(19) United States
(12) Patent Application Publication
(10) Pub. No.: US 2024/0303694 A1
(43) Pub. Date: Sep. 12, 2024

(54) AUDIENCE LOCATION SCORING

(71) Applicant: CATALINA MARKETING CORPORATION, St. Petersburg, FL (US)

(72) Inventors: Qian Wang, Atlanta, GA (US); Qingjin Fan, Chicago, IL (US); Daniel Cropsey, Fox River Grove, IL (US)

(21) Appl. No.: 18/552,275

(22) PCT Filed: Mar. 31, 2022
(86) PCT No.: PCT/US2022/022857

§ 371 Date: Sep. 25, 2023

Related U.S. Application Data
(60) Provisional application No. 63/169,717, filed on Apr. 1, 2021.

(51) Int. Cl. G06Q 30/0251; G06Q 30/0242

(52) U.S. Cl. CPC G06Q 30/0261; G06Q 30/0242; G06Q 30/0255

(57) ABSTRACT

A method to score audience location for an advertising campaign is provided. The method includes identifying, for a target audience group, a demographic data, a visit history, or a purchase history of a consumer within the target audience group, defining a target location for an advertising campaign based on a penetration of the target audience, training, to predict an exposure to the advertising campaign by the target audience, a model that includes multiple target locations within a retailer network, generating a score for a likelihood that the target audience will have sufficient exposure at one or more locations within a geographic zone, and providing, for a display in a client device, a map indicative of the score for the target locations. A system and a memory storing instructions which, when executed by a processor, cause the system to perform the above method, and the processor, are also provided.

### CROSS-REFERENCE TO RELATED APPLICATIONS

The present disclosure is related and claims priority under the PCT to U.S. Prov. Pat. Appln. No. 63/169,717, entitled AUDIENCE LOCATION SCORING, to Qinglin FAN et al., filed on Apr. 1, 2021, the contents of which are hereby incorporated by reference, in their entirety, for all purposes.

### BACKGROUND

### Field

The present disclosure is related to scaling and scoring locations by likelihood of audience exposure to a consumer item. More specifically, the present disclosure is directed to identifying and ranking areas of high concentration of potential consumers for a product or with certain characteristics, and to targeting an out-of-home or digital contextual advertising campaign accordingly.

### Brief Background Description

Targeted advertising campaigns typically rely on a direct, one-to-one form of communication between the advertising agent and the consumer (e.g., via a mobile device, or a household electronic appliance such as a desktop computer, digital television, and the like). However, many potential consumers are left out of these campaign strategies because, no matter how large a consumer network may be, there will be a larger audience out of reach of the network, and they are more difficult to reach via highly targeted digital media (e.g., “out of home” or OOH audience). Many of these traditional methods of reaching these consumers, like OOH billboards or in-store signage, lack the ability to target specific audiences on a one-to-one basis, making it inefficient without some means to prioritize the likely concentration of audience consumers for that specific location. The increasing need for digital contextual targeting due higher consumer privacy expectations also benefits from identifying higher concentrations of desirable consumers in a geographic area.

### BRIEF DESCRIPTION OF THE DRAWINGS

FIG. 1 illustrates an architecture in a system for identifying and locating an audience for an advertising campaign in a geographic region, according to some embodiments.

FIG. 2 illustrates details of exemplary devices used in one embodiment of a system, according to some embodiments.

FIG. 3 illustrates data components used by a statistics tool to predict a response from a population segment to an advertisement campaign, according to some embodiments.

FIGS. 4A-4C illustrate maps generated by an audience location engine for an advertising campaign, according to some embodiments.

FIG. 5 illustrates a visiting radius map for distance weighting consumer features, according to some embodiments.

FIG. 6 is a flow chart illustrating steps in a method to provide a map with target audience locations, according to some embodiments.

FIG. 7 is a flow chart illustrating steps in a method to form a map with target audience locations, according to some embodiments.

FIG. 8 is a block diagram illustrating an exemplary computer system with which the devices and methods disclosed herein may be implemented, according to some embodiments.

In the figures, elements having the same or similar reference numeral include the same or similar features and attributes, unless explicitly stated otherwise.

### SUMMARY

In a first embodiment, a computer-implemented method for audience location scoring includes identifying demographic pattern, visit pattern, and urbanicity level of geographic zones. The computer-implemented method also includes defining a target location for an advertising campaign based on the locality of the target audience, wherein the target audience can be the buyer for pre-selected items, validating the target location based on known features and patterns of the locations, generating a score for a likelihood that the audience will see the ads in different locations, and providing, for a display in a client device, a map indicative of the score for multiple target locations.

In a second embodiment, a system includes one or more processors and a memory storing instructions which, when executed by the one or more processors, cause the system to perform operations. The operations include: to identify, for a target audience group, a demographic data, a visit history, or a purchase history of a consumer within the target audience group, to define a target location for an advertising campaign based on a penetration of the target audience group, to train, to predict an exposure to the advertising campaign by the target audience group, a model that includes multiple target locations within a retailer network, to generate, with the model, a score for a likelihood that the target audience group will have sufficient exposure at one or more locations within a geographic zone, and to provide, for a display in a client device, a map indicative of the score for the target locations.

In a third embodiment, a computer-implemented method includes retrieving, from multiple consumers, at least one of an urbanicity feature, a visit history feature, and a demographic feature, the urbanicity feature associated with a population density, and the visit history feature associated with consumer visits to a store. The computer-implemented method also includes identifying a centroid for a common geographic area and aggregating the urbanicity feature, the visit history feature, or the demographic feature based on the centroid, determining an event predictor value associated with the centroid based on at least one feature aggregated from the urbanicity feature, the visit history feature, and the demographic feature, and forming a map including the common geographic area, indicative of a geographic distribution of the event predictor value.

In yet another embodiment, a system includes one or more processors and a memory storing instructions which, when executed by the one or more processors, cause the system to perform operations. The operations include: retrieve, from multiple consumers, at least one of an urbanicity feature, a visit history feature, and a demographic feature, the urbanicity feature associated with a population density, and the visit history feature associated with consumer visits to a store. The operations also include identify a centroid for a common geographic area and aggregate the urbanicity feature, the visit history feature, or the demographic feature based on the centroid, determine an event predictor value associated with the centroid based on at least one feature aggregated from the urbanicity feature, the visit history feature, and the demographic feature, and form a map including the common geographic area, indicative of a geographic distribution of the event predictor value.

In a further embodiment, a system includes a first means for storing instructions and a second means for executing the instructions to perform a method. The method includes: identifying, for a target audience group, a demographic data, a visit history, or a purchase history of a consumer within the target audience group, defining a target location for an advertising campaign based on a penetration of the target audience group, to train, predicting an exposure to the advertising campaign by the target audience group, a model that includes multiple target locations within a retailer network, generating, with the model, a score for a likelihood that the target audience group will have sufficient exposure at one or more locations within a geographic zone, and providing, for a display in a client device, a map indicative of the score for the target locations.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

To reach OOH audiences, or any potential consumer that is not well identified as part of a consumer network, current OOH advertising resources place untargeted ads in retail parking lots, store walls, cash registers, billboards, and other high traffic areas. However, these efforts are not targeted and typically result in unnecessary expenditure, not to mention the annoyance for potential consumers who frequently receive non-relevant advertising. To resolve the above problem arising in the technical area of consumer advertising, embodiments as disclosed herein include methods for scoring different locations to expand channels for displaying advertisements for pre-selected items or pre-defined target audience groups.

In some embodiments, an OOH or geographic contextual audience location scoring system scales and scores different locations across a pre-selected region by likelihood of a desired audience (who are targeted for pre-selected items or have certain characteristics and behaviors) being at that location. Audience location exposure can be defined by one or more of a purchase history in a consumer network, a visit history (e.g., to a given retail store or business), or demographic data (e.g., age, gender, socioeconomic status, educational background, place of residence, household income, and the like). Audience purchase history is used to define a desired audience or as a factor to determine target locations with sufficient audience exposure. The purchase histories may be determined via a frequent shopper card of the consumer who is linked to retailer networks or other identifiable shopper purchase capture (e.g., receipt scanning, e-commerce purchase history). The visit features may be determined via a mobile device used by the consumer that is coupled to a network and that provides, upon authorization and limits set by the consumer, location data to the network. The demographic data is extracted by linking the household ID to the consumer under different networks.

Embodiments as disclosed herein provide customized advertisements on digital and static media and billboards across different localities over a pre-selected region. Thus, instead of randomly selecting the advertisements for media display on a billboard or even broadcasted on a mobile device, local radio or TV, embodiments as disclosed herein determine a likelihood of target audience group exposure at a given location, leading to potential higher rate of returns.

In some embodiments, a system as disclosed herein generates a profile of multiple locations within a pre-selected region (e.g., zip+4 code or census block group within the US). The pre-selected region may include a geographical area of interest in an advertising campaign for the pre-selected item, or a group of pre-selected items. This would provide new dimensionality to field analytics and sales data to help generate data-driven insights and data-driven decisions to advertisement engines and protocols.

### General Overview

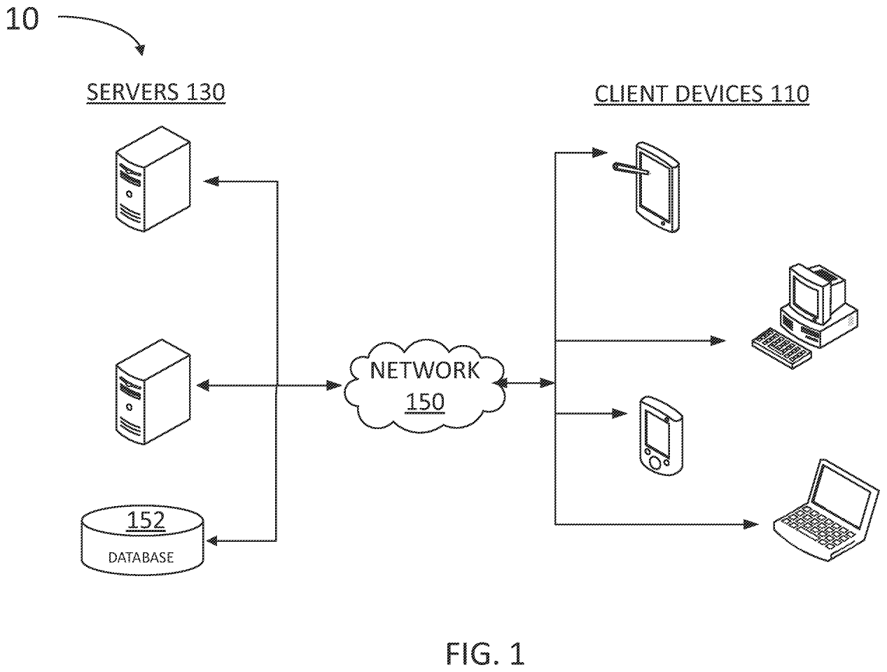

FIG. 1 illustrates an architecture in a system 10 for identifying and locating an audience for an advertising campaign in a geographic region, according to some embodiments. System 10 includes servers 130, client devices 110, and at least one database 152, communicatively coupled with each other through a network 150. Servers 130 and client devices 110 have a memory, including instructions which, when executed by a processor, cause servers 130 and client devices 110 to perform at least some of the steps in methods as disclosed herein. In some embodiments, a server 130 includes an audience location engine to infer statistical assessments as to the receptiveness to a certain advertising campaign for retail products of a population across a geographic area based on information retrieved from one or more client devices 110 of a limited group of consumers in the geographic area. A statistical assessment may be generated by server 130 from a retailer visit history and other demographic and location factors (e.g., urbanicity), retrieved from client devices 110 and stored in a memory of the server or in database 152. In some embodiments, a user of one of client devices 110 is an advertising agent accessing the audience location engine in a server 130 to design and execute an advertising campaign on behalf of a brand manufacturer, or a retail store. In some embodiments, the user of one of client devices 110 may include the brand manufacturer or the retail store itself.

Servers 130 and database 152 may include any device having an appropriate processor, memory, and communications capability for hosting a history log of retail store visit data from consumers in a geographic area, an advertisement database, and an audience location engine. The audience location engine may be accessible by various client devices 110 over network 150. In some embodiments, servers 130 may include a dynamic rendering server, a publisher, or a supply side platform (SSP) server providing media content for user download and downstream, and a demand side platform (DSP) server Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the audience location engine and the history log on one or more of servers 130. Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

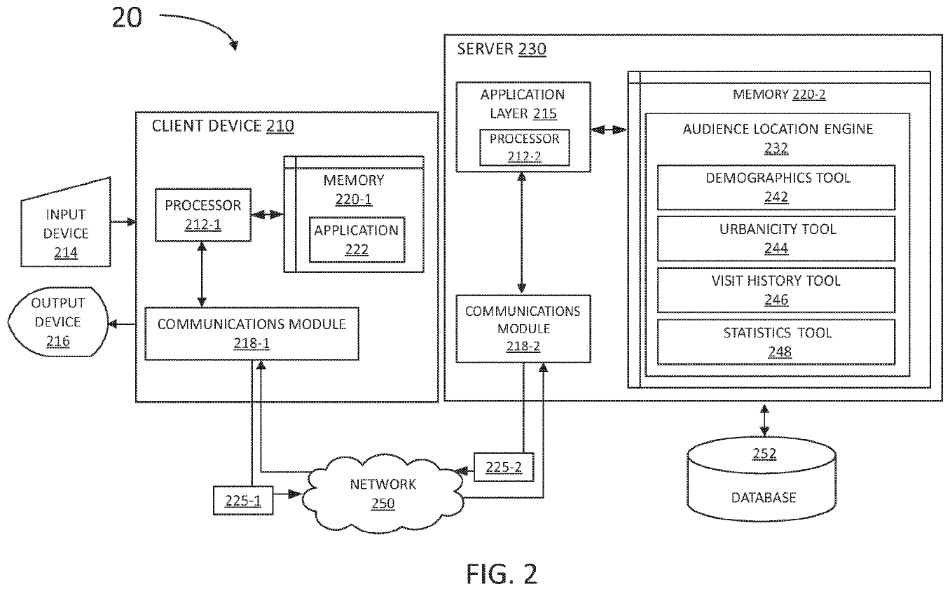

FIG. 2 illustrates details of exemplary devices used in one embodiment of a system 20, according to some embodiments. A client device 210, a server 230, and a database 252 are communicatively coupled over a network 250 (cf. client devices 110, servers 130, database 152, and network 150) via respective communications modules 218-1 and 218-2 (hereinafter, collectively referred to as “communication modules 218”). Communications modules 218 are configured to interface with network 250 to send and receive information, such as data, requests, responses, and commands to other devices on network 250. In some embodiments, communications modules 218 can be, for example, modems or Ethernet cards. Client device 210 may be coupled with an input device 214 and with an output device 216. Input device 214 may include a keyboard, a mouse, a pointer, or even a touchscreen display that a user (e.g., a consumer) may utilize to interact with the client device. Likewise, output device 216 may include a display and a speaker with which the user may retrieve results from client device 210.

Client device 210 may also include a processor 212-1 configured to execute instructions stored in a memory 220-1, and to cause client device 210 to perform at least some of the steps in methods consistent with the present disclosure. Memory 220-1 may further include an application 222 storing specific instructions which, when executed by processor 212-1, provide a data payload 225-1 to server 230, and cause a data payload 225-2 from server 230 to be displayed for the user of client device 210. Data payloads 225-1 and 225-2 will be referred to, hereinafter, as “data payloads 225.” Data payload 225-1 may include location data provided by application 222 (e.g., a Geo-location application, and the like), mobile device IDs, frequent shopper IDs, household IDs, and the like. In some embodiments, data payload 225-1 may indicate a visit of a consumer to a retail store in a selected location, the duration of the visit, and even the items purchased by the consumer during the visit. In some embodiments, client device 210 is itself a server that collects location information and visit history information from multiple consumers within a selected area, and provides the aggregated information to server 230. Data payload 225-2 may include a map identifying an audience for advertising campaigns to be displayed for a creative design client. The map may be interactive and enable a user with client device 210 to zoom in/out, pan, and request heat maps and probability charts overlaid on the map. Application 222 may be installed by and perform scripts and other routines provided through an application layer 215 in server 230. Application layer 215 includes a processor 212-2 configured to execute instructions stored in a memory 220-2. In some embodiments, a consumer, having a frequent shopper identification or not, may download application 222 from an “online store” of a retailer, or a brand manufacturer. In some embodiments, application 222 includes instructions which, when executed by processor 212-1, cause a display in output device 216 to display a portal of an audience location engine 232 hosted by server 230. Accordingly, application 222 may include instructions, which when executed by processor 212-1, cause an output device 216 to display the map identifying an audience for advertising campaigns to be displayed for a creative design client.

Server 230 includes a memory 220-2, a processor 212-2, and communications module 218-2. Processor 212-2 is configured to execute instructions, such as instructions physically coded into processor 212-2, instructions received from software in memory 220-2, or a combination of both. Memory 220-2 includes an audience location engine 232 configured to prepare a digital payload 225-2 for the consumer with client device 210. In some embodiments, audience location engine 232 generates the map identifying an audience for advertising campaigns to be displayed for a creative design client. Audience location engine 232 is configured to infer, based on data retrieved from consumers that are part of a retail network, the likelihood that a certain advertising campaign will have a sizeable audience within a selected geographic region. In this regard, client device 210 may be a smartphone or other mobile device used by a consumer while visiting a retail store a certain distance away from home. In some embodiments, client device 210 may include a computer or any other network connected device at the point of sale (POS) in a retail store. In yet other embodiments, client device 210 may include a server or centralized computer in a retail store server, providing real-time purchasing data to server 230 hosting audience location engine 232. Audience location engine 232 may include a demographics tool 242, an urbanicity tool 244, a visit history tool 246, and a statistics tool 248.

Demographics tool 242 collects demographics information from multiple consumers. The demographic information may include age, gender, income (if available, or purchasing power), and other socio-economic factors such as education level, number of individuals in a household, dependents, and the like. Urbanicity tool 244 may determine an urbanicity level for a given location based on a population density in the area where the consumer lives. In some embodiments, urbanicity tool 244 assigns each location with one of three urbanicity levels for: “urban,” “suburban,” or “rural” consumers. Visit history tool 246 determines a number of visits of a given consumer to a retail store, including a time spent by the consumer at the store, and even the items purchased by the consumer during the visit. Visit history tool 246 may also register the distance traveled by each consumer to a specific retail store, in addition to information about the purchase made during each visit. Accordingly, audience location engine 232 may determine how far a given consumer may be willing to travel to purchase what type of product. Statistics tool 248 is configured to determine a probability that a given population within a certain demographic segment, in a given geographic area, will be receptive to an advertisement for a product. Accordingly, statistics tool 248 may indicate the likelihood that a consumer be exposed to an advertisement for a product in a certain geographic area, and that it will actually purchase the product at a retail store.

In some embodiments, demographics tool 242, urbanicity tool 244, visit history tool 246, and statistics tool 248 may include a neural network model, or any nonlinear or linear regression algorithm to perform data correlations and to associate values to and ascertaining a distance measure between semantic concepts and textual descriptions such as consumer attributes and branded product attributes, purchasing probabilities, and confidence levels.

Application layer 215 produces the output of audience location engine 232 in the form of data payload 225-2 including an interactive map that the user of client device 210 may zoom in/out, pan, and select different data overlays and heat maps. In some embodiments, audience location engine 232 may retrieve raw data with consumer purchasing history, product sales history, or retail store sales history, from database 252. In yet other embodiments, audience location engine 232 may retrieve raw data from a server 230 in a retail store, or retailer media network, or a server 230 hosted by a brand manufacturer.

In one or more implementations, database 252 may include a list of frequent consumers of one or more retailers. The consumers may have a frequent shopper identification associated with the retailers. In some embodiments, in addition to one or more “brick and mortar” physical locations of stores for the retailer, the retailer may host a retailer media network hosted by a network server (e.g., server 230). Server 230 may create, update, and maintain database 252, including frequent shopper identifications and purchase history logs. In that regard, database 252 may be hosted by the retailer or a brand manufacturer, while audience location engine 232 may be hosted by a DSP server. Accordingly, the DSP server may have access to one or more databases 252, through business agreements with one or more retailers or product manufacturers. In certain aspects, processor 212-2 in a server 230 hosted by a retailer may be configured to determine data for database 252 by obtaining consumer purchasing data identifying the consumer via the frequent shopper identification used at multiple purchasing events in multiple locations, over a pre-selected span of time. Processors 212-1 and 212-2, and memories 220-1 and 220-2, will be collectively referred to, hereinafter, as “processors 212” and “memories 220,” respectively.

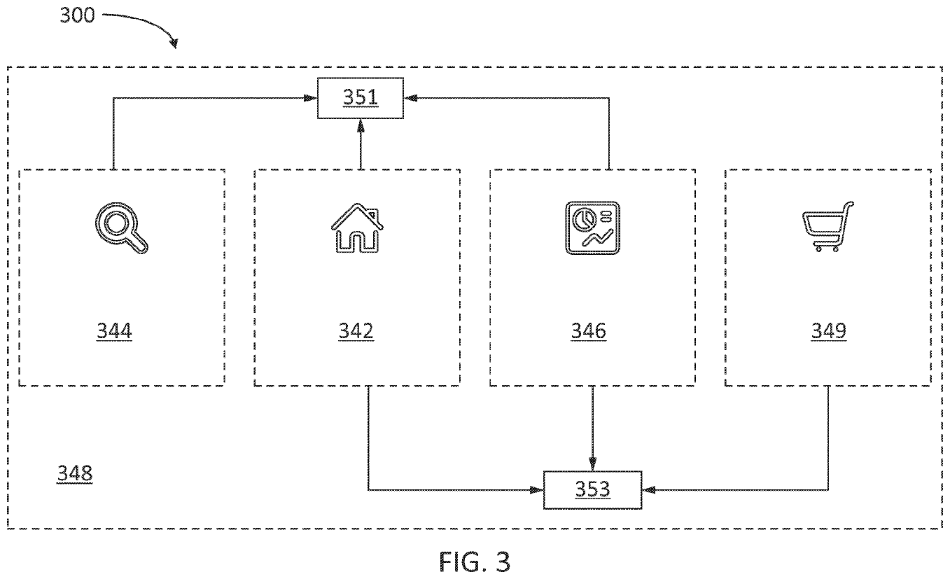

FIG. 3 illustrates data components 300 used by a statistics tool 348 to predict a response from a population segment to an advertisement campaign, according to some embodiments. An urbanicity data 344 may include three values: urban, suburban, and rural, assigned to each of multiple consumers in a given demographic segment. A demographics data 342 provides a multi-dimensional population profile such as ethnicity, age, gender, occupation, education, region, and the like. A visit history data 346 includes data collected from mobile devices indicative of location, time, and duration of a consumer activity (e.g., a visit to a retail store), over a certain period of time. And a purchase history 349 includes information such as shopper habits (e.g., ‘when’ and ‘where’ a consumer shops for what products) associated with one or more retailer stores and chains.

A predictor 351 retrieves urbanicity data 344, demographics data 342, and visit history data 346 to determine a likelihood of a given response 353 from a consumer. To do this, statistics tool 348 may perform correlations between urbanicity data 344, demographics data 342, and visit history data 346 to establish a frequency of occurrence of purchasing events given different data configurations. Statistics tool 348 may include regression and/or classification algorithms such as neural networks, machine learning, and artificial intelligence algorithms.

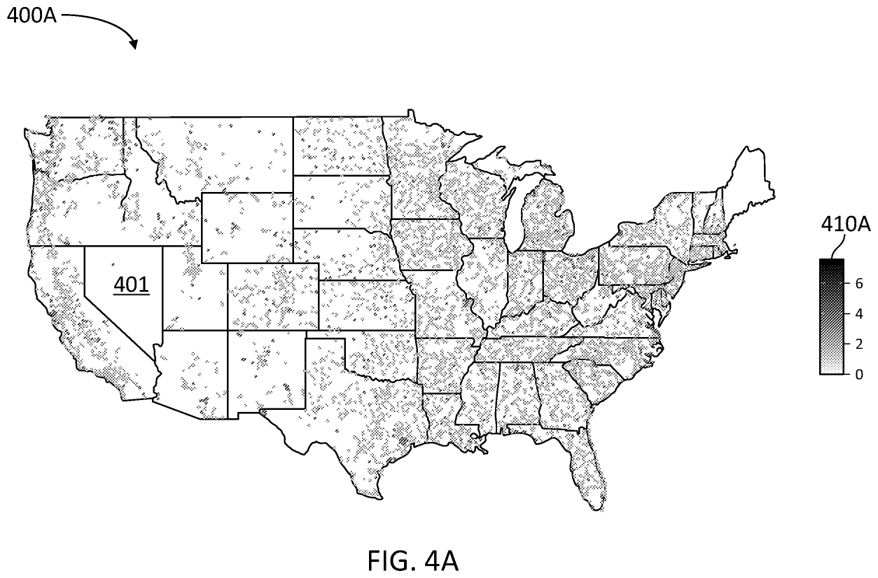

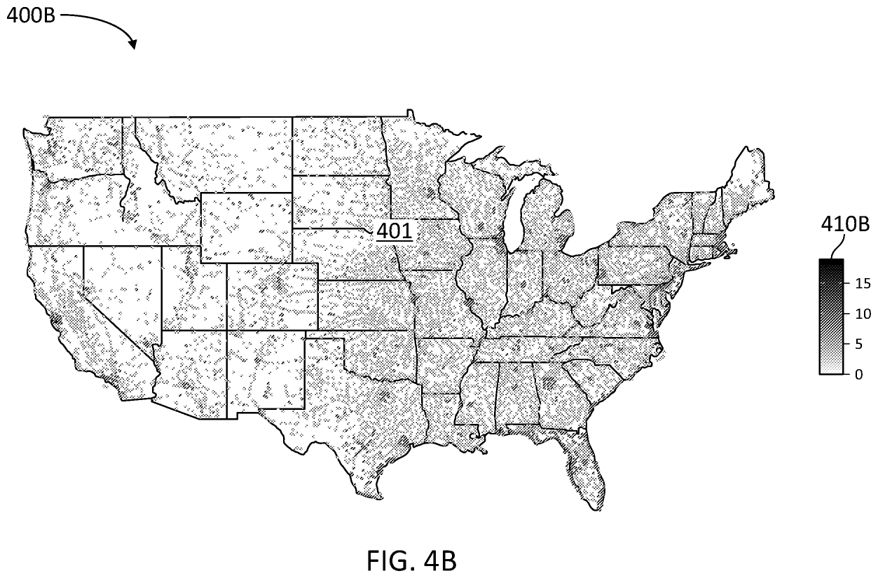

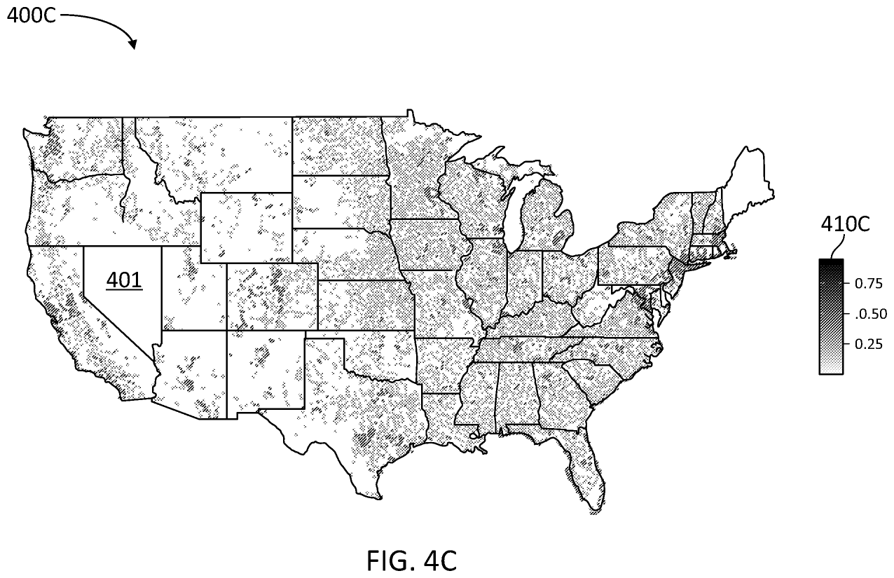

FIGS. 4A-4C illustrate a household ID map 400A, a visit scatter map 400B, and an audience exposure map 400C (hereinafter, collectively referred to as “maps 400”) generated by an audience location engine for an advertising campaign (e.g., audience location engine 232), according to some embodiments. Maps 400 may cover a wide geographic area 401 (e.g., the continental United States). In some embodiments, at least one of maps 400 is interactive, so that a user may zoom in/out over a selected geographic area to view more detailed data therein.

Household ID map 400A is a scatter plot indicating a total household count distribution. The dots in household ID map 400A are shaded to indicate geographic areas having a given number (in a logarithmic shade scale) of household IDs recorded 410A (e.g., as part of a retailer media network).

Visit scatter map 400B is a scatter plot indicating a total number of visits to a retail store distribution. The dots in visit scatter map 400B are shaded to indicate (in a logarithmic shade scale) a total number of visits (410B) to a retail store for consumers within the retail media network in a given time period.

Audience location map 400C is a scatter map illustrating a probability density distribution for the predicted probability of audience exposure, as disclosed herein. The predictors used to predict the probability of audience exposure include demographic features, urbanicity information, and visit patterns. In some embodiments, machine learning algorithms may be used to create map 400C. For example, in some embodiments, a gradient boosting model may compute an importance of each predictor feature, based on impurity of splits (e.g., the probability that an element would be incorrectly classified by randomly labeling it according to the distribution of target labels). In some embodiments, a bar chart is generated (cf. Table 1) to visualize the importance of each feature. For example, the features in Table 1 may be associated with a likelihood of a consumer from a household with total income>=$150,000 per year. In some embodiments, a heat map can be used to visualize the strength level of predicted probability of audience exposure.

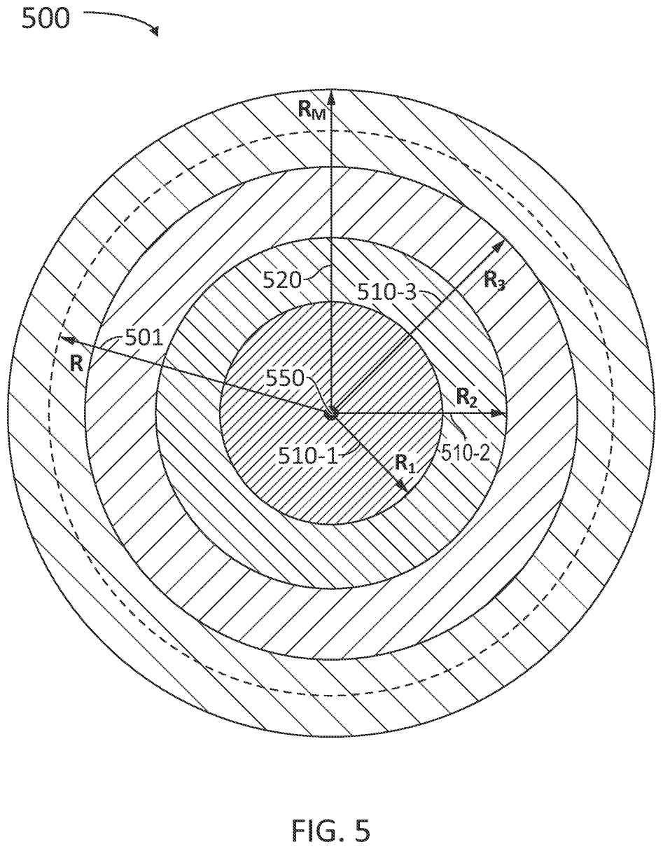

FIG. 5 illustrates a visiting radius map 500 for distance weighting consumer features (e.g., urbanicity and demographics), according to some embodiments. Visiting radius map 500 is indicative of how far a consumer is willing to travel from their place of residence to a retail store. In some embodiments, distance threshold 510-1, 510-2, and 510-3 (hereinafter, collectively referred to as “distance thresholds 510”) cover 10%, 25%, and 50% of visits by place type and urbanicity, respectively. A visiting radius 501, R, is aggregated as the median radius for all zip+4 locations with the same urbanicity type and place type. Accordingly, in some embodiments, for a selected “center” in a locality (e.g., any given point in a map (cf. map 400C), multiple values may be added (e.g., integrated) within a certain radius 501, R, of the center, to integrate a weighted total of visits, residents, or purchases associated with zip+4 location. The calculation includes the addition of a number of visits to various places of interest or retail stores (predictor and response), a demographic value (predictor and response), and a purchase value (response).

The greater the distance a given location is from a center 550, the lower weight will be assigned from that location to the integrated probability associated with the center. Beyond a maximum value 520, the weight is set to zero and the corresponding probability value is dissociated from center point 550. Accordingly, systems as disclosed herein build a distance table for each of multiple locations and summing up the product of weights and features renders the weighted feature values. The data used to build a distance table based on visiting radius map 500 is collected from consumers that belong to a retail media network, and whose mobile devices are registered and traceable within the retail media network (per consumer authorization and set limits).

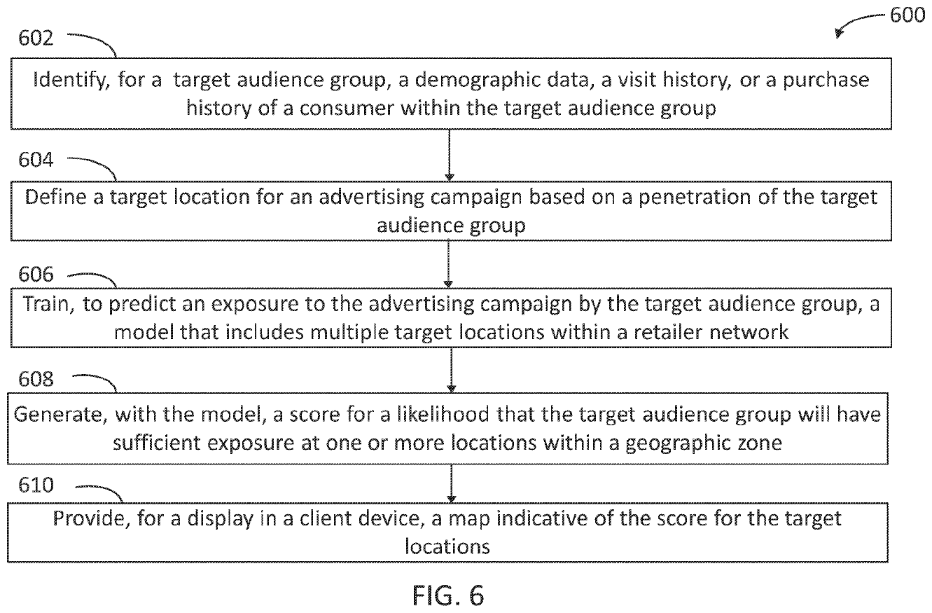

FIG. 6 is a flow chart illustrating steps in a method 600 to provide a map with target audience locations, according to some embodiments. Embodiments as disclosed herein may include steps in method 600 at least partially performed by computers, servers, client devices, and databases communicatively coupled with each other via a network, as disclosed herein (e.g., client devices 110 and 210, servers 130 and 230, databases 152 and 252, and networks 150 and 250). In some embodiments, one or more steps in method 600 may be at least partially performed by an audience location engine running a demographics tool, an urbanicity tool, a visit history tool, or a statistics tool, as disclosed herein (cf. audience location engine 232, demographics tool 242, urbanicity tool 244, visit history tool 246, and statistics tool 248). In some embodiments, a method consistent with the present disclosure may include at least one or two of the steps in method 600 performed in any order, simultaneously, quasi-simultaneously, or overlapping in time.

Step 602 includes identifying, for a target audience group, a demographic data, a visit history, or a purchase history of a consumer within the target audience group. In some embodiments, step 602 includes aggregating the demographic data, the visit history, or the purchase history to a location associated with the consumer. In some embodiments, step 602 includes receiving a longitude and latitude information of a mobile device of a consumer from a server hosting a location application installed in the mobile device of the consumer. In some embodiments, step 602 includes determining a radius threshold from a centroid that a selected portion of consumers within a demographic segment are willing to travel to purchase a type of product. In some embodiments, step 602 includes selecting the consumer that is subscribed to the retailer network.

Step 604 includes defining a target location for an advertising campaign based on the penetration of the target audience group. In some embodiments, step 604 includes defining the target location based on information describing where the target audience group lives, places that the target audience group visits, or items that the target group purchases.

Step 606 includes training, to predict an exposure to the advertising campaign by the target audience group, a model that includes multiple target locations within a retailer network. In some embodiments, step 606 includes selecting a demographic pattern within the location, an urbanicity level within the location, and a visiting pattern within the location. In some embodiments, the features here are independent from the definition of a pre-selected target audience group.

Step 608 includes generating, with the model, a score for a likelihood that the target audience group will have sufficient exposure at one or more locations in the US. In some embodiments, step 608 includes identifying a predicted audience exposure in the locations. For example, when a pre-selected target audience includes diaper buyers, then step 608 includes predicting the probability of having a diaper buyer's audience exposure meeting penetration requirement.

Step 610 includes providing, for a display in a client device, a map indicative of the predicted score for the target locations. In some embodiments, step 610 further includes determining a list of demographic features for a consumer sorted by a weight factor indicative of a likelihood that the consumer purchases a type of product based on a weighted average.

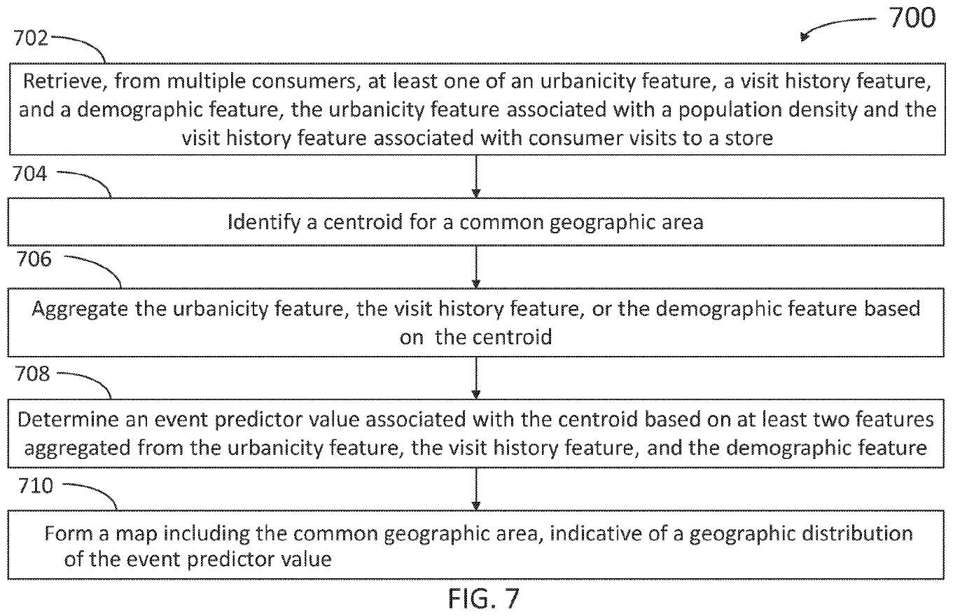

FIG. 7 is a flow chart illustrating steps in a method to form a map with target audience locations, according to some embodiments. Embodiments as disclosed herein may include steps in method 700 at least partially performed by computers, servers, client devices, and databases communicatively coupled with each other via a network, as disclosed herein (e.g., client devices 110 and 210, servers 130 and 230, databases 152 and 252, and networks 150 and 250). In some embodiments, one or more steps in method 700 may be at least partially performed by an audience location engine running a demographics tool, an urbanicity tool, a visit history tool, or a statistics tool, as disclosed herein (cf. audience location engine 232, demographics tool 242, urbanicity tool 244, visit history tool 246, and statistics tool 248). In some embodiments, a method consistent with the present disclosure may include at least one or two of the steps in method 700 performed in any order, simultaneously, quasi-simultaneously, or overlapping in time.

Step 702 includes retrieving, from multiple consumers, at least one of an urbanicity feature, a visit history feature, and a demographic feature, the urbanicity feature associated with a population density, and the visit history feature associated with consumer visits to a store. In some embodiments, step 702 includes retrieving at least one of an urban value, a suburban value, and a rural value.

Step 704 includes identifying a centroid for a common geographic area. In some embodiments, step 704 further includes retrieving a store location within the common geographic area, and selecting a radius from the store, wherein the visit history feature is associated with a consumer that resides within the radius from the store.

Step 706 includes aggregating the urbanicity feature, the visit history feature, or the demographic feature based on the centroid.

Step 708 includes determining an event predictor value associated with the centroid based on at least two features aggregated from the urbanicity feature, the visit history feature, and the demographic feature. In some embodiments, step 708 includes correlating the urbanicity feature, the demographic feature, and the visit history feature. In some embodiments, step 708 includes reducing a dimension of the visit history feature.

Step 710 includes forming a map including the common geographic area, indicative of a geographic distribution of the event predictor value.

### Hardware Overview

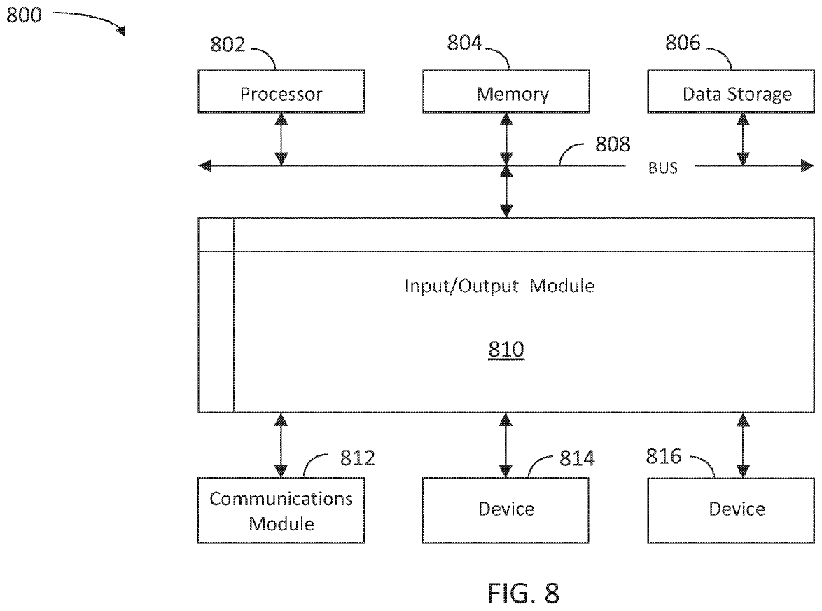

FIG. 8 is a block diagram illustrating an exemplary computer system 800 with which the client device 110 and 210 and server 130 and 230 of FIGS. 1 and 2, and the methods of FIGS. 6 and 7 can be implemented. In certain aspects, the computer system 800 may be implemented using hardware or a combination of software and hardware, either in a dedicated server, or integrated into another entity, or distributed across multiple entities.

Computer system 800 (e.g., client device 110 and server 130) includes a bus 808 or other communication mechanism for communicating information, and a processor 802 (e.g., processors 212) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, e.g., one or more modules of computer program instructions encoded on a computer-readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled with bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 (e.g., communications modules 218) include networking interface cards, such as Ethernet cards and modems. In certain aspects, input/output module 810 is configured to connect to a plurality of devices, such as an input device 814 (e.g., input device 214) and/or an output device 816 (e.g., output device 216). Exemplary input devices 814 include a keyboard and a pointing device, e.g., a mouse or a trackball, by which a consumer can provide input to the computer system 800. Other kinds of input devices 814 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 816 include display devices, such as an LCD (liquid crystal display) monitor, for displaying information to the consumer.

According to one aspect of the present disclosure, the client device 110 and server 130 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., networks 150 and 250) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a clause may be amended to include some or all of the words (e.g., instructions, operations, functions, or components) recited in other one or more clauses, one or more words, one or more sentences, one or more phrases, one or more paragraphs, and/or one or more clauses.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

The clauses are not intended to be limited to the aspects described herein, but are to be accorded the full scope consistent with the language clauses and to encompass all legal equivalents. Notwithstanding, none of the clauses are intended to embrace subject matter that fails to satisfy the requirements of the applicable patent law, nor should they be interpreted in such a way.

### RECITATION OF EMBODIMENTS

The present disclosure includes the following embodiments:

Embodiment I: A computer-implemented method for audience location scoring includes identifying demographic pattern, visit pattern, and urbanicity level of geographic zones. The computer-implemented method also includes defining a target location for an advertising campaign based on the locality of the target audience, wherein the target audience can be the buyer for a pre-selected item, validating the target location based on known features and patterns of the locations, generating a score for a likelihood that the audience will see the ads in different locations, and providing, for a display in a client device, a map indicative of the score for multiple target locations.

Embodiment II: A system includes one or more processors and a memory storing instructions which, when executed by the one or more processors, cause the system to perform operations. The operations include: to identify, for a target audience group, a demographic data, a visit history, or a purchase history of a consumer within the target audience group, to define a target location for an advertising campaign based on a penetration of the target audience group, to train, to predict an exposure to the advertising campaign by the target audience group, a model that includes multiple target locations within a retailer network, to generate, with the model, a score for a likelihood that the target audience group will have sufficient exposure at one or more locations within a geographic zone, and to provide, for a display in a client device, a map indicative of the score for the target locations.

Embodiment III: A computer-implemented method includes retrieving, from multiple consumers, at least one of an urbanicity feature, a visit history feature, and a demographic feature, the urbanicity feature associated with a population density, and the visit history feature associated with consumer visits to a store. The computer-implemented method also includes identifying a centroid for a common geographic area and aggregating the urbanicity feature, the visit history feature, or the demographic feature based on the centroid, determining an event predictor value associated with the centroid based on at least two features aggregated from the urbanicity feature, the visit history feature, and the demographic feature, and forming a map including the common geographic area, indicative of a geographic distribution of the event predictor value.

Consistent with the present disclosure, the features of embodiments I, II, and III may be combined with any one or more of the below elements, wherein:

Element 1, wherein identifying a demographic data for the target audience group includes extracting a binary value for the target audience group in one of an urban category, a suburban category, and a rural category. Element 2, wherein validating the target location further includes assessing a performance of a model that generates the score based on a known feature. Element 3, further including aggregating the demographic data, the visit history, or the purchase history to a location score associated with the consumer. Element 4, wherein defining a target location for an advertising campaign includes defining the target location based on information describing where the target audience group lives, a visit place for the target audience group, or a purchase item associated with the target audience group Element 5, wherein training a model to predict an exposure to the advertising campaign by the target audience group includes selecting a demographic pattern within a location, urbanicity level within the location, and visiting pattern within the location. In some embodiments, the features here are independent from the definition of pre-selected target audience group.

Element 6, wherein identifying a visit history includes receiving a longitude and latitude information of a mobile device of a consumer from a server hosting a location application installed in the mobile device of the consumer. Element 7, wherein identifying a visit history includes determining a radius threshold from a centroid that a selected portion of consumers within a demographic segment are willing to travel to purchase a type of product. Element 8, wherein identifying the demographic data, the visit history, or the purchase history of a consumer within the target audience group includes selecting the consumer that is subscribed to the retailer network. Element 9, further including determining a list of demographic features for a consumer sorted by a weight factor indicative of a likelihood that the consumer purchases a type of product based on a weighted average.

Element 10, wherein to identify a demographic data for the target audience group the one or more processors execute instructions to extract a binary value for the target audience group in one of an urban category, a suburban category, and a rural category. Element 11, wherein to validate the target location the one or more processors further execute instructions to assess a performance of a model that generates the score based on a known feature. Element 12, wherein the one or more processors further execute instructions to aggregate the demographic data, the visit history, or the purchase history to a geographic zone value associated with the consumer. Element 13, wherein to define a target location for an advertising campaign the one or more processors execute instructions to define the target location based on information describing where the target audience group lives, a visit place for the target audience group, or a purchase item associated with the target audience group.

1. A computer-implemented method, comprising:
identifying, for a target audience group, a demographic data, a visit history, or a purchase history of a consumer within the target audience group;
defining a target location for an advertising campaign based on a penetration of the target audience group;
training, to predict an exposure to the advertising campaign by the target audience group, a model that includes multiple target locations within a retailer network;
generating, with the model, a score for a likelihood that the target audience group will have sufficient exposure at one or more locations within a geographic zone; and
providing, for a display in a client device, a map indicative of the score for the target locations.

2. The computer-implemented method of claim 1, wherein identifying a demographic data for the target audience group comprises extracting a binary value for the target audience group in one of an urban category, a suburban category, and a rural category.

3. The computer-implemented method of claim 1, wherein validating the target location further comprises assessing a performance of a model that generates the score based on a known feature.

4. The computer-implemented method of claim 1, further comprising aggregating the demographic data, the visit history, or the purchase history to a specific geographic area or census block group value associated with the consumer.

5. The computer-implemented method of claim 1, wherein defining a target location for an advertising campaign comprises defining the target location based on information describing where the target audience group lives, a visit place for the target audience group, or a purchase item associated with the target audience group.

6. The computer-implemented method of claim 1, wherein training a model to predict an exposure to the advertising campaign by the target audience group comprises selecting at least one of a demographic pattern within a specific geographic area, an urbanicity level within the specific geographic area, and a visiting pattern within the specific geographic area, independent of a pre-selected target audience group.

7. The computer-implemented method of claim 1, wherein identifying a visit history comprises receiving a longitude and latitude information of a mobile device of a consumer from a server hosting a location application installed in the mobile device of the consumer.

8. The computer-implemented method of claim 1, wherein identifying a visit history comprises determining a radius threshold from a centroid that a selected portion of consumers within a demographic segment are willing to travel to purchase a type of product.

9. The computer-implemented method of claim 1, wherein identifying the demographic data, the visit history, or the purchase history of a consumer within the target audience group comprises selecting the consumer that is subscribed to the retailer network.

10. The computer-implemented method of claim 1, further comprising determining a list of demographic features for a consumer sorted by a weight factor indicative of a likelihood that the consumer purchases a type of product based on a weighted average.

11. A system, comprising:
one or more processors; and
a memory storing instructions which, when executed by the one or more processors, cause the system to perform operations, comprising to:
identify, for a target audience group, a demographic data, a visit history, or a purchase history of a consumer within the target audience group;
define a target location for an advertising campaign based on a penetration of the target audience group;
train, to predict an exposure to the advertising campaign by the target audience group, a model that includes multiple target locations within a retailer network;
generate, with the model, a score for a likelihood that the target audience group will have sufficient exposure at one or more locations within a geographic zone; and
provide, for a display in a client device, a map indicative of the score for the target locations.

12. The system of claim 11, wherein to identify a demographic data for the target audience group the one or more processors execute instructions to extract a binary value for the target audience group in one of an urban category, a suburban category, and a rural category.

13. The system of claim 11, wherein to validate the target location the one or more processors further execute instructions to assess a performance of a model that generates the score based on a known feature.

14. The system of claim 11, wherein the one or more processors further execute instructions to aggregate the demographic data, the visit history, or the purchase history to a specific geographic area value associated with the consumer.

15. The system of claim 11, wherein to define a target location for an advertising campaign the one or more processors execute instructions to define the target location based on information describing where the target audience group lives, a visit place for the target audience group, or a purchase item associated with the target audience group.

16. A computer-implemented method, comprising:
retrieving, from multiple consumers, at least one of an urbanicity feature, a visit history feature, and a demographic feature, the urbanicity feature associated with a population density, and the visit history feature associated with consumer visits to a store;
identifying a centroid for a common geographic area;
aggregating the urbanicity feature, the visit history feature, or the demographic feature based on the centroid;
determining an event predictor value associated with the centroid based on at least two features aggregated from the urbanicity feature, the visit history feature, and the demographic feature; and
forming a map including the common geographic area, indicative of a geographic distribution of the event predictor value.

17. The computer-implemented method of claim 16, wherein retrieving an urbanicity feature comprises retrieving at least one of an urban value, a suburban value, and a rural value.

18. The computer-implemented method of claim 16, further comprising retrieving a store location within the common geographic area, and selecting a radius from the store, wherein the visit history feature is associated with a consumer that resides within the radius from the store.

19. The computer-implemented method of claim 16, wherein determining an event predictor value associated with the centroid comprises correlating the urbanicity feature, the demographic feature, and the visit history feature.

20. The computer-implemented method of claim 16, wherein determining an event predictor value comprises reducing a dimension of the visit history feature.
